(19) United States
(12) Patent Application Publication
(10) Pub. No.: US 2023/0162121 A1
(43) Pub. Date: May 25, 2023

(54) UNIFIED, CROSS-CHANNEL, MULTIDIMENSIONAL INSIGHT GENERATION

(71) Applicant: Accenture Global Solutions Limited, Dublin (IE)

(72) Inventor: Shannon Copeland, Atlanta, GA (US)

(73) Assignee: Accenture Global Solutions Limited, Dublin (IE)

(21) Appl. No.: 17/453,700

(22) Filed: Nov. 5, 2021

(51) Int. Cl. G06Q 10/06

(52) U.S. Cl. CPC G06Q 10/06393; G06Q 10/067

(57) ABSTRACT

Unified, cross-channel, multidimensional insight generation is presented according to embodiments of the present invention. Embodiments include receiving communications between a business development representative (‘BDR’) and a customer across disparate communications channels, each channel comprising a channel type, channel communications protocol, and channel form; normalizing the disparate communications in dependence upon normalization rules; summarizing the normalized communications in dependence upon summarization rules; creating semantic triples in dependence upon the summarized and normalized communications including applying a sales-progress-directed taxonomy and ontology; creating a multidimensional vector in dependence upon the semantic triples; wherein the multidimensional vector includes one or more attributes of a sales cycle; and identifying one or more insights in dependence upon the multidimensional vector.

### BACKGROUND

Inside sales typically refers to sales made over the telephone, email, text, and other electronic communications channels. Such communications are often in disparate forms, often occur asynchronously, and are often not correlated with one another. While analyzing each communications may be useful to an organization, it would be advantageous to unify the content of each of these communications and use that unified content for purposes of business development and improved sales.

### BRIEF DESCRIPTION OF THE DRAWINGS

FIG. 1 sets forth a network diagram illustrating an example system for unified, cross-channel, multidimensional insight generation according to embodiments of the present invention.

FIG. 2 sets forth a diagram illustrating an example system for unified, cross-channel, multidimensional insight generation according to embodiments of the present invention.

FIG. 3 sets forth a line drawing of a graph.

FIG. 4 sets forth a block diagram of automated computing machinery comprising an example of a computer useful as a voice server according to embodiments of the present invention.

FIG. 5 sets forth a block diagram of automated computing machinery comprising an example of a computer useful as a triple server according to embodiments of the present invention.

FIG. 6 sets forth a flowchart illustrating an example method of unified, cross-channel, multidimensional insight generation according to example embodiments of the present invention.

### DETAILED DESCRIPTION OF EXAMPLE EMBODIMENTS

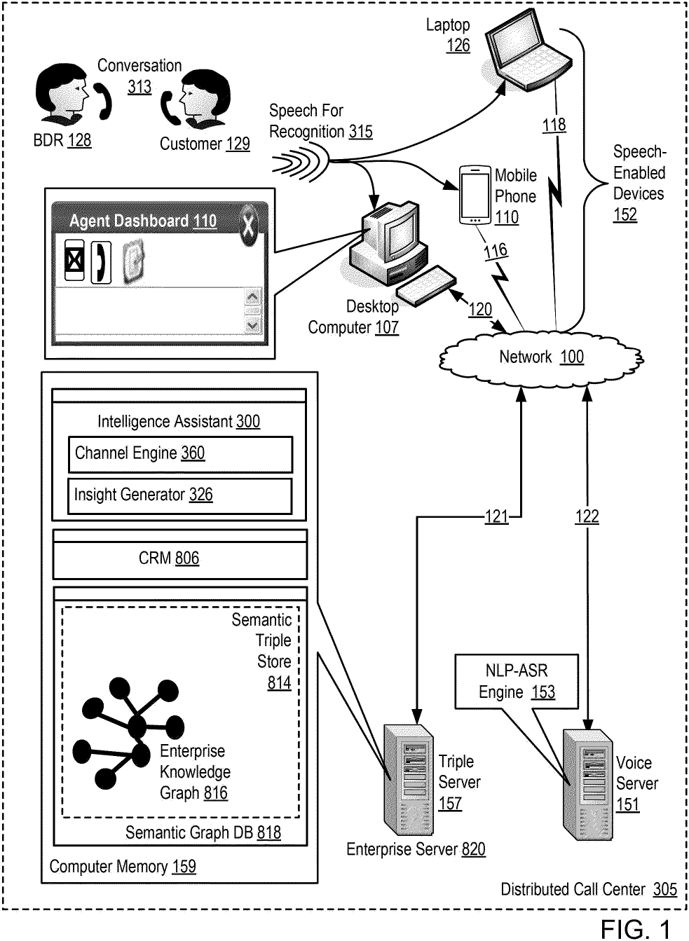

Example methods, systems, apparatuses, and products for unified, cross-channel, multidimensional insight generation are described with reference to the accompanying drawings, beginning with FIG. 1. FIG. 1 sets forth a network diagram illustrating an example system for unified, cross-channel, multidimensional insight generation according to embodiments of the present invention. The example system of FIG. 1 includes one or more speech-enabled devices (152), a triple server (157), and a voice server (151). A speech-enabled device is automated computing machinery configured to accept and recognize speech from a user and often express to a user voice prompts and speech responses. Speech-enabled devices in the example of FIG. 1 include a desktop computer (107), a mobile phone (110), a laptop computer (126), and an enterprise server (820) supporting an intelligence assistant (300) according to embodiments of the present invention. Each speech-enabled device in this example is coupled for data communications through a network (100) to the triple server (157) and the voice server (151). The speech-enabled devices of FIG. 1 are also capable of communications over various other channels such as text, chat, email, telephony, chatbots, as well as communications through static means such as CRM data, catalogs, sales information, leads, call notes, and others as will occur to those of skill in the art.

The overall example system illustrated in FIG. 1 operates generally for unified, cross-channel, multidimensional insight generation by receiving communications between a business development representative (‘BDR’) (128) and a customer (129) across disparate communications channels, each channel comprising a channel type, channel communications protocol, and channel form. In the example of FIG. 1, the BDR (128) and the customer (129) may communicate through speech (315) over for example a VOIP communications channel, through text effected with a mobile phone (110), email sent through a laptop (126) and others discussed in more detail below and as will occur to those of skill in the art.

The system of FIG. 1 operates also by normalizing the disparate communications in dependence upon normalization rules and summarizing the normalized communications in dependence upon summarization rules. Normalizing the disparate communications may be carried out by converting speech communications to text and maintaining text communications in text. Normalization may also include converting the text into a uniform font such as all capitalized letters in the same font, applying uniform spacing between words in the text, removing punctuation from the text, and so on.

The system of FIG. 1 also operates by summarizing the normalized communications in dependence upon summarization rules. Summarizing the normalized communications in dependence upon summarization rules may be carried out by applying rules to reduce the text of the communications into more concise and meaningful statements. Such concise statements improve the effectiveness of parsing the summarized communications into semantic triples for insight generation. Summarizing the normalized communications may be carried out by reducing the overall content of the communications in a predetermined matter to focus the text of the communications for application of a taxonomy and ontology. In some embodiments, summarization rules may include removing predetermined adverbs, removing designated first words, adjusting or removing contractions, replacing known phrases with a standardized language pattern, and others as will occur to those of skill in the art.

The system of FIG. 1 also operates for insight generation by creating semantic triples in dependence upon the summarized and normalized communications including applying a sales-progress-directed taxonomy and ontology.

The system of FIG. 1 also includes creating a multidimensional vector in dependence upon the semantic triples; wherein the multidimensional vector includes one or more attributes of a sales cycle. Example attributes of a sales cycle include industry, BANT (budget, authority, need, and timeline), cost or pricing discussed on one or more sales calls, specific products discussed, key gatekeepers to the sales process, next best action in the customer relationship, a job title of the customer, cost of product questions and others. Identifying (912) one or more insights in dependence upon the multidimensional vector may include other types of insights including whether an interaction with a customer had positive sentiments, whether the sales cycle has positive momentum an others as will occur to those of skill in the art.

The system of FIG. 1 also operates of insight generation by identifying one or more insights in dependence upon the multidimensional vector. Identifying the one or more insights in the example of FIG. 1 often includes identifying a stage in a sales cycle. Identifying one or more insights in dependence upon the multidimensional vector may include comparing the multidimensional vector with one or more predetermined vectors identifying stages in the sales cycle. Such comparison may include comparing vector distance in each dimension of the multidimensional vector individually, against a weighted prioritization, or other algorithms as will occur to those of skill in the art.

As mentioned above, unified, cross-channel, multidimensional insight generation according to various embodiments of the present invention is speech-enabled. Often the speech for recognition is dictated by a BDR in preparation of a call between the BDR and a customer or the speech of that conversation itself. A word of digitized speech in this example is speech for recognition from a BDR (128) or a conversation between the BDR (128) and a customer. The speech for recognition can be an entire conversation, where, for example, all persons speaking are in the same room, and the entire conversation is picked up by a microphone on a speech-enabled device. The scope of speech for recognition can be reduced by providing to a speech-enabled device conversation from only to one person or a person on one side of a conversation, as only through a microphone on a headset. The scope of speech for recognition can be reduced even further by providing for recognition only speech that responds to a prompt from, for example, a VoiceXML dialogue executing on a speech-enabled device. As the scope of speech for recognition is reduced, data processing burdens are reduced across the system as a whole, although it remains an option, in some embodiments at least, to recognize entire conversations and stream across flow of all words in the conversation.

Speech from a BDR in the example of FIG. 1 is recognized into digitized speech by operation of a natural language processing speech recognition (“NLP-SR”) engine (153), shown here disposed upon a voice server (151), but also amenable to installation on speech-enabled devices. The speech so digitized (508) may be parsed into a triple of a description logic for use in unified, cross-channel, multidimensional insight generation according to embodiments of the present invention.

A triple is a three-part statement expressed in a form of logic. Depending on context, different terminologies are used to refer to effectively the same three parts of a statement in a logic. In first order logic, the parts are called constant, unary predicate, and binary predicate. In the Web Ontology Language (“OWL”) the parts are individual, class, and property. In some description logics the parts are called individual, concept, and role.

In this example description, the elements of a triple are referred to as subject, predicate, and object- and expressed like this: <subject> <predicate> <object>. There are many modes of expression for triples. Elements of triples can be represented as Uniform Resource Locaters (“URLs”), Uniform Resource Identifiers (“URIs”), or International Resource Identifiers (“IRIs”). Triples can be expressed in N-Quads, Turtle syntax, TriG, Javascript Object Notation or “JSON,” the list goes on and on. The expression used here, subject-predicate-object in angle brackets, is one form of abstract syntax, optimized for human readability rather than machine processing, although its substantive content is correct for expression of triples. Using this abstract syntax, here are examples of triples:
<Bob> <is a> <person>
<Bob> <is a friend of> <Alice>
<Bob> <is born on> <the 4^{th} of July 1990>
<Bob> <is interested in> <the Mona Lisa>
<the Mona Lisa> <was created by> <Leonardo da Vinci>
<the video ‘La Joconde a Washington’> <is about> <the Mona Lisa>

The same item can be referenced in multiple triples. In this example, Bob is the subject of four triples, and the Mona Lisa is the subject of one triple and the object of two. This ability to have the same item be the subject of one triple and the object of another makes it possible to effect connections among triples and connected triples form graphs.

The example of FIG. 1 includes a semantic graph database (818) which includes an enterprise knowledge graph (816). A semantic graph is a configuration of memory that uses graph structures, nodes and edges, to represent and store data. A key concept of this kind of configuration is the graph (or edge or relationship), which directly relates data items in a data store. Such a graph database contrasts with more conventional storage such as a logical table, where links among data are mere indirect metadata, and queries search for data within the store using joins to collect related data. Semantic graphs, by design, make explicit relations among data that can be difficult to model in relational systems or logical tables.

In the example of FIG. 1, the semantic graph database (816) includes a semantic triple store (814). The semantic triple store (804) of FIG. 1 includes triple stores for access by the intelligence assistant (300), the CRM (806) and other components. The triple store (814) of FIG. 1 contains structured definitions of words not special to any particular knowledge domain, where each structured definition of the general language store is implemented with a triple of description logic. The triple store (814) also includes structured definitions of words for recognition in particular knowledge domains such as products, jargon of an industry, particular industries, geographic areas, and so on, where each structured definition of the product triple store is implemented with a triple of description logic.

The semantic triple store (814) in the example of FIG. 1 includes triples defining various forms of information useful in insight generation according to embodiments of the present invention. Such triples may be queried by an intelligence assistant engine to retrieve insights, to prepare call notes parsed into semantic triples, identify customer connections, identify relevant use cases, identify chats, identify installed technology of a customer, produce talk tracks, identify product recommendations, and so on as will occur to those of skill in the art. The information stored in knowledge graph (816) of FIG. 1 is presented for explanation and not for limitation. The enterprise knowledge graph may be used to store other information useful in insight generation according to embodiments of the present invention as will occur to those of skill in the art.

The example of FIG. 1 includes a CRM (806). Such a CRM is a CRM system configured for the use of BDRs and other users of the enterprise. Often data stored on and accessed by the CRM is data owned by the enterprise itself and collected over time for the use of various users of the organization as will occur to those of skill in the art. In other embodiments of the present invention, the CRM may be owned by a client of the call center and the data residing in that CRM is owned by the client..

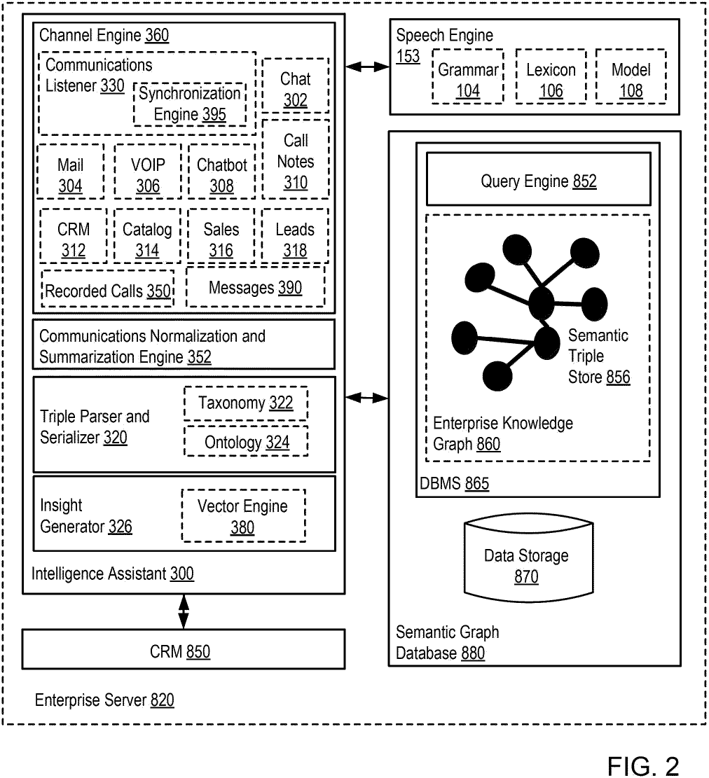

The example of FIG. 1 also includes an intelligence assistant (300). The intelligence assistant of FIG. 1 is a speech-enabled platform capable of insight generation and management of the semantic graph database as discussed in more detail below with reference to FIG. 2. The intelligence assistant (300) and the CRM (806) are connected for data communications to an enterprise server (820), a triple server (157), and a voice server (151).

The intelligence assistant (300) of FIG. 1 includes a channel engine (360). The channel engine (360) of FIG. 1 provides a communications listener (330) that listens over disparate communications channels and provides the communication for use by the intelligence engine in developing insights according to embodiments of the present invention. As discussed below with reference to FIG. 2, examples of disparate communications channels include chat, email, VOIP, leads, recorded calls, chatbots, text messages, call notes and others as will occur to those of skill in the art.

The intelligence assistant (300) of FIG. 1 also includes an insight generator (326). In the example of FIG. 1, many components useful in insight generation according to embodiments of the present invention are maintained in computer memory (159). In the example of FIG. 1, computer memory (159) includes cache, random access memory (“RAM”), disk storage, and so on, most forms of computer memory. Computer memory (159) so configured typically resides on speech-enabled devices, or as shown here, upon one or more triple servers (157), voice servers, or enterprise servers (820)

For further explanation, FIG. 2 sets forth a diagram illustrating an example system for unified, cross-channel, multidimensional insight generation according to embodiments of the present invention. The system of FIG. 2 includes an enterprise server (820). The example enterprise server of FIG. 2 is implemented as one or more computers that stores programs serving the collective needs of an enterprise rather than a single user or a single department. An enterprise server can refer to both the computer hardware and its main software, operating system, firmware, additional software, and so on. Residing on the enterprise server (820) in the example system of FIG. 2 is an intelligence assistant (300) that includes a channel engine (360), a communications normalization and summarization engine (352), a triple parser and serializer (320), and an insight generator (326). Also residing on the enterprise server (820) in the example of FIG. 2 is a speech engine (153) and a semantic graph database (880). The enterprise server of FIG. 1 is depicted as unified automated computing machinery but in many embodiments of the present invention such an enterprise server and its components may, and often will, be distributed.

The intelligence assistant (300) of FIG. 2 is a targeted collection of artificial intelligence-based technologies including natural and semantic language processing that processes unstructured communications into structured information and generates in dependence upon the structured information insights available for sales assistance, ultimately driving improved quality and efficiency of the BDR. The intelligence assistant (300) of FIG. 2 includes a channel engine (360). In the example of FIG. 2, the channel engine (360) is configured to administer communications across disparate communications channels. The channel engine (360) of FIG. 2 provides an always-on communications listener (330) that listens over each of the communications channels and administers the consumption of the disparate communications for use by the intelligence engine.

In some embodiments of the present invention, a communications channel is associated with a communications type, communications protocol, and communications form. For example, a communications channel characterized as type email is administered using a protocol such as Simple Mail Transfer Protocol (‘SMTP’), and may be associated with a form of text communications.

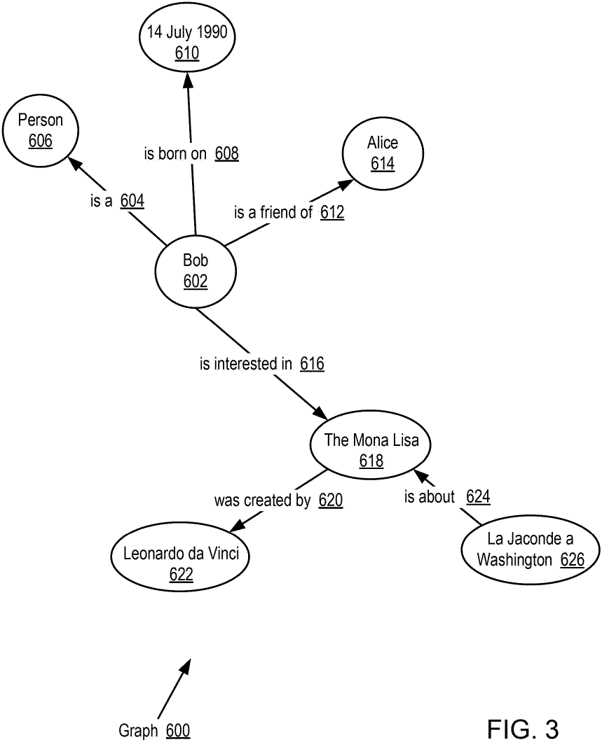

In the example of FIG. 2, the channel engine (360) is configured to administer communications through chat (302) and chatbots (308) through the use of, for example, instant messaging protocols such as SMS, Bonjour, MSNP, and many others as will occur to those of skill in the art. The example channel engine (360) administers communications with email (304) using various email protocols such as IMAP, POP3, SMTP, Exchange, and others. The example channel engine (360) may administer communications using voice over Internet Protocol (‘VOIP’) communications with live, recorded (350), or automated participants. The channel engine of FIG. 3 is configured to administer communications through messages (390) protocols such as SMS messaging protocols and others as will occur to those of skill in the art. The communications channel may also administer communications with engines, services, and other resources to retrieve static call notes (310), communicated with a CRM (312) static catalogs (314), sales engines (316), lead engines (318), and other resources such as through the use of API’s or other invocation methods.

The communications listener (330) of FIG. 2 also includes a synchronization engine (395), a module of automated computing machinery that synchronizes the disparate communications for unified cross-channel, multidimensional insight generation according to embodiments of the present invention. In some embodiments, communications through disparate channels are synchronized in dependence upon one or attributes of the communications between the tele-agent and the customer. Such attributes may be identified from metadata associated with the communications, the content of the communications itself or in other ways as will occur to those of skill in the art. Communications may be synchronized in dependence upon:
the tele-agent ID
the customer ID
the sales campaign,
the time of communication between a tele-agent and a particular customer
the content of communication including for example, product identification,
and in other ways as will occur to those of skill in the art.

Such synchronized communications often provide an improved body of communications for insight generation.

Communications administered by the communications engine may be text-based and often that text is maintained to be ingested by the intelligence assistant. Other example communications include live or recorded speech which is converted to text by the speech engine (153) for consumption by the intelligence assistant. Regardless of the original form, whether text or speech, the communications once either maintained in text or converted to text are then normalized.

The example of FIG. 2 includes a communications normalization and summarization engine (352). The normalization and summarization engine (352) places the communications in a uniform format such as removing punctuation, placing the text in a predetermined font such as all capital letters of a particular font, and removing extras spaces and providing uniform spacing of the words of the text of the communication. In addition to normalization, the communications are summarized according to summarization rules. Summarization rules focus the content of the communications for application of a taxonomy and ontology such that the communications may be parsed into semantic triples with increased meaning for use in identifying sales insights.

The intelligence assistant (300) of FIG. 2 therefore includes a triple parser and serializer (306). The triple parser of FIG. 2 takes as input a file in some format such as the standard RDF/XML format, which is compatible with the more widespread XML standard. The triple parser takes such a file as input and converts it into an internal representation of the triples that are expressed in that file. At this point, the triples are stored in the triple store are available for all the operations of that store. Triples parsed and stored in the triple store can be serialized back out using the triple serializer (306).

The semantic graph database (818) of FIG. 2 is a type of graph database that is capable of integrating heterogeneous data from many sources and making links between datasets. It focuses on the relationships between entities and is able to infer new knowledge out of existing information. The semantic technology of FIG. 2 can link new information automatically, without manual user intervention or the database being explicitly pre-structured. This automatic linking is powerful when fusing data from inside and outside company databases, such as corporate email, documents, spreadsheets, customer support logs, relational databases, government/public/industry repositories, news feeds, customer data, social networks and much more. In traditional relational databases this linking involves complex coding, data warehouses and heavy pre-processing with exact a priori knowledge of the types of queries to be asked.

The semantic graph database (818) of FIG. 2 includes a database management system ‘DBMS’ (316) and data storage (320). The DBMS of FIG. 2 includes an enterprise knowledge graph (816) and a query engine (314). The enterprise knowledge graph of FIG. 2 is a structured representation of data stored in data storage (320). The query engine of FIG. 2 receives structured queries and retrieves stored information in response.

The system of FIG. 2 includes a speech engine (153). The example speech engine includes an NLP engine and ASR engine for speech recognition and text-to-speech (‘TTS’) for generating speech. The example speech engine (153) includes a grammar (104), a lexicon (106), and a language-specific acoustic model (108) as discussed in more detail below.

The intelligence assistant (300) of FIG. 2 includes a channel engine (360), a module of automated computing machinery that administers communications over disparate communications channels such that information may be ingested into the intelligent assistant without limitation to its original form or communications channel. The channel engine (360) establishes communications sessions using disparate protocols such as SMS, HTTP, VOIP and other telephony, POTS, email, text streams, static text, and many others as will occur to those of skill in the art.

The triple parser of Figure creates triples in dependence upon a taxonomy (322) and an ontology (324). The taxonomy (322) includes words or sets of words with defined semantics that will be stored as triples. To parse speech into semantic triples the triple parser receives text converted from speech by the speech engine and identifies portions of that text that correspond with the taxonomy and forms triples using the defined elements of the taxonomy.

The triple parser of FIG. 2 also creates triples in dependence upon an ontology (324). An ontology is a formal specification that provides sharable and reusable knowledge representation. An ontology specification includes descriptions of concepts and properties in a domain, relationships between concepts, constraints on how the relationships can be used and other concepts and properties.

The enterprise server (820) of FIG. 2 includes a CRM (806), automated computing machinery that provides contact management, sales management, agent productivity administration, and other services targeted to improved customer relations and ultimately customer satisfaction and enterprise profitability. The example CRM of FIG. 2 manages manage customer relationships across the entire customer lifecycle, individual sales cycles, campaigns, driving marketing, sales, and customer service and so on. Such information is usefully ingested, parsed, and stored by the intelligence assistant for use in generating insights according to embodiments of the present invention.

The intelligence assistant (300) of FIG. 2 includes an insight generator (326) that includes a vector engine (380). The insight generator of FIG. 2 operates for unified, cross-channel, multidimensional insight generation by creating a multidimensional vector in dependence upon the semantic triples; wherein the multidimensional vector includes one or more attributes of a sales cycle; and identifying one or more insights in dependence upon the multidimensional vector.

For further explanation of relations among triples and graphs, FIG. 3 sets forth a line drawing of a graph (600). The example graph of FIG. 3 implements in graph form the example triples set forth above regarding Bob and the Mona Lisa. In the example of FIG. 3, the graph edges (604, 608, 612, 616, 620, 624) represent respectively relations among the node, that is, represent the predicates <is a>, <is a friend of>, <is born on>, <is interested in>, <was created by>, and <is about>. The nodes themselves represent the subjects and objects of the triples, <Bob>, <person>, <Alice>, <the 4^{th} of July 1990>, <the Mona Lisa>, <Leonardo da Vinci>, and <the video ‘La Joconde a Washington’>.

In systems of knowledge representation, knowledge represented in graphs of triples, including, for example, knowledge representations implemented in Prolog databases, Lisp data structures, or in RDF-oriented ontologies in RDFS, OWL, and other ontology languages. Search and inference are effected against such graphs by search engines configured to execute semantic queries in, for example, Prolog or SPARQL. Prolog is a general-purpose logic programming language. SPARQL is a recursive acronym for “SPARQL Protocol and RDF Query Language.” Prolog supports queries against connected triples expressed as statements and rules in a Prolog database. SPARQL supports queries against ontologies expressed in RDFS or OWL or other RDF-oriented ontologies. Regarding Prolog, SPARQL, RDF, and so on, these are examples of technologies explanatory of example embodiments of the present invention. Thus, such are not limitations of the present invention. Knowledge representations useful according to embodiments of the present invention can take many forms as may occur to those of skill in the art, now or in the future, and all such are now and will continue to be well within the scope of the present invention.

A description logic is a member of a family of formal knowledge representation languages. Some description logics are more expressive than propositional logic but less expressive than first-order logic. In contrast to first-order logics, reasoning problems for description logics are usually decidable. Efficient decision procedures therefore can be implemented for problem of search and inference in description logics. There are general, spatial, temporal, spatiotemporal, and fuzzy descriptions logics, and each description logic features a different balance between expressivity and reasoning complexity by supporting different sets of mathematical constructors.

Search queries are disposed along a scale of semantics. A traditional web search, for example, is disposed upon a zero point of that scale, no semantics, no structure. A traditional web search against the keyword “derivative” returns HTML documents discussing the literary concept of derivative works as well as calculus procedures. A traditional web search against the keyword “differential” returns HTML pages describing automobile parts and calculus functions.

Other queries are disposed along mid-points of the scale, some semantics, some structure, not entirely complete. This is actually a current trend in web search. Such systems may be termed executable rather than decidable. From some points of view, decidability is not a primary concern. In many Web applications, for example, data sets are huge, and they simply do not require a 100 percent correct model to analyze data that may have been spidered, scraped, and converted into structure by some heuristic program that itself is imperfect. People use Google because it can find good answers a lot of the time, even if it cannot find perfect answers all the time. In such rough-and-tumble search environments, provable correctness is not a key goal.

Other classes of queries are disposed where correctness of results is key, and decidability enters. A user who is a BDR in a data center speaking by phone with an automotive customer discussing a front differential is concerned not to be required to sort through calculus results to find correct terminology. Such a user needs correct definitions of automotive terms, and the user needs query results in conversational real time, that is, for example, within seconds.

In formal logic, a system is decidable if there exists a method such that, for every assertion that can be expressed in terms of the system, the method is capable of deciding whether or not the assertion is valid within the system. In practical terms, a query against a decidable description logic will not loop indefinitely, crash, fail to return an answer, or return a wrong answer. A decidable description logic supports data models or ontologies that are clear, unambiguous, and machine-processable. Undecidable systems do not. A decidable description logic supports algorithms by which a computer system can determine equivalence of classes defined in the logic. Undecidable systems do not. Decidable description logics can be implemented in C, C++, SQL, Lisp, RDF/RDFS/OWL, and so on. In the RDF space, subdivisions of OWL vary in decidability. Full OWL does not support decidability. OWL DL does.

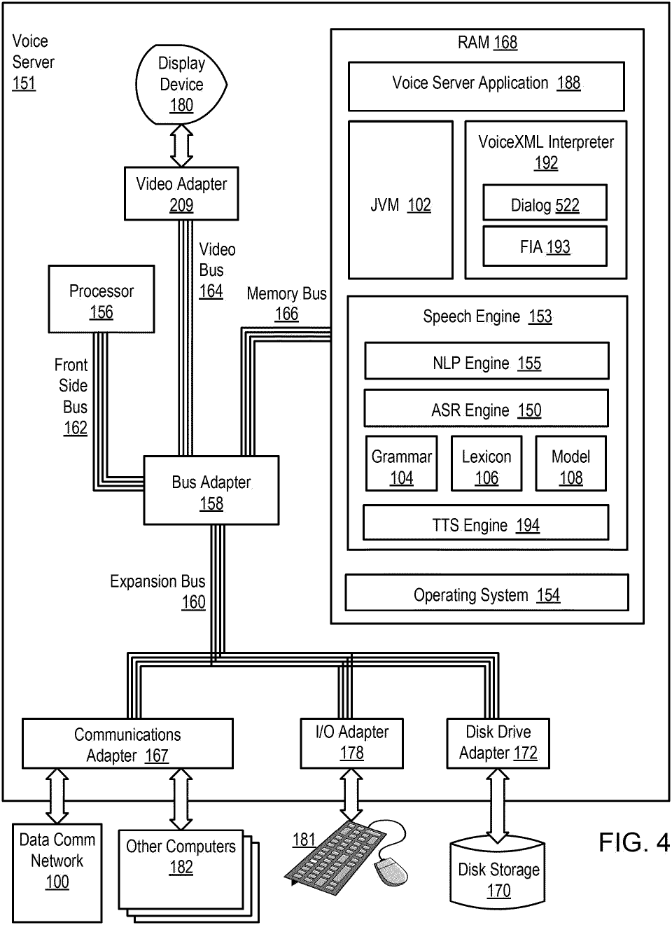

Unified, cross-channel, multidimensional insight generation according to embodiments of the present invention, particularly in a thin-client architecture, may be implemented with one or more voice servers. A voice server is a computer, that is, automated computing machinery, that provides speech recognition and speech synthesis. For further explanation, therefore, FIG. 4 sets forth a block diagram of automated computing machinery comprising an example of a computer useful as a voice server (151) for a speech-enabled device useful according to embodiments of the present invention. The voice server (151) of FIG. 4 includes at least one computer processor (156) or ‘CPU’ as well as random access memory (168) (‘RAM’) which is connected through a high-speed memory bus (166) and bus adapter (158) to processor (156) and to other components of the voice server.

Stored in RAM (168) is a voice server application (188), a module of computer program instructions capable of operating a voice server in a system that is configured for use in configuring memory according to some embodiments of the present invention. Voice server application (188) provides voice recognition services for multimodal devices by accepting requests for speech recognition and returning speech recognition results, including text representing recognized speech, text for use as variable values in dialogs, and text as string representations of scripts for semantic interpretation. Voice server application (188) also includes computer program instructions that provide text-to-speech (‘TTS’) conversion for voice prompts and voice responses to user input in speech-enabled applications such as, for example, speech-enabled browsers, X+V applications, SALT applications, or Java Speech applications, and so on.

Voice server application (188) may be implemented as a web server, implemented in Java, C++, Python, Perl, or any language that supports X+V, SALT, VoiceXML, or other speech-enabled languages, by providing responses to HTTP requests from X+V clients, SALT clients, Java Speech clients, or other speech-enabled client devices. Voice server application (188) may, for a further example, be implemented as a Java server that runs on a Java Virtual Machine (102) and supports a Java voice framework by providing responses to HTTP requests from Java client applications running on speech-enabled devices. And voice server applications that support embodiments of the present invention may be implemented in other ways as may occur to those of skill in the art, and all such ways are well within the scope of the present invention.

The voice server (151) in this example includes a natural language processing speech recognition (“NLP-SR”) engine (153). An NLP-SR engine is sometimes referred to in this paper simply as a ‘speech engine.’ A speech engine is a functional module, typically a software module, although it may include specialized hardware also, that does the work of recognizing and generating human speech. In this example, the speech engine (153) is a natural language processing speech engine that includes a natural language processing (“NLP”) engine (155). The NLP engine accepts recognized speech from an automated speech recognition (‘ASR’) engine, processes the recognized speech into parts of speech, subject, predicates, object, and so on, and then converts the recognized, processed parts of speech into semantic triples for inclusion in triple stores.

The speech engine (153) includes an automated speech recognition (‘ASR’) engine for speech recognition and a text-to-speech (‘TTS’) engine for generating speech. The speech engine also includes a grammar (104), a lexicon (106), and a language-specific acoustic model (108). The language-specific acoustic model (108) is a data structure, a table or database, for example, that associates speech feature vectors (‘SFVs’) with phonemes representing pronunciations of words in a human language often stored in a vocabulary file. The lexicon (106) is an association of words in text form with phonemes representing pronunciations of each word; the lexicon effectively identifies words that are capable of recognition by an ASR engine. Also stored in RAM (168) is a Text-To-Speech (‘TTS’) Engine (194), a module of computer program instructions that accepts text as input and returns the same text in the form of digitally encoded speech, for use in providing speech as prompts for and responses to users of speech-enabled systems.

The grammar (104) communicates to the ASR engine (150) the words and sequences of words that currently may be recognized. For further explanation, distinguish the purpose of the grammar and the purpose of the lexicon. The lexicon associates with phonemes all the words that the ASR engine can recognize. The grammar communicates the words currently eligible for recognition. The two sets at any particular time may not be the same.

Grammars may be expressed in a number of formats supported by ASR engines, including, for example, the Java Speech Grammar Format (‘JSGF’), the format of the W3C Speech Recognition Grammar Specification (‘SRGS’), the Augmented Backus-Naur Format (‘ABNF’) from the IETF’s RFC2234, in the form of a stochastic grammar as described in the W3C’s Stochastic Language Models (N-Gram) Specification, and in other grammar formats as may occur to those of skill in the art. Grammars typically operate as elements of dialogs, such as, for example, a VoiceXML <menu> or an X+V <form>. A grammar’s definition may be expressed in-line in a dialog. Or the grammar may be implemented externally in a separate grammar document and referenced from with a dialog with a URI. Here is an example of a grammar expressed in JSFG:

<grammar scope=“dialog” ><! [CDATA[
#JSGF V1.0;
grammar command;
<command> = [remind me to] call | phone | telephone <name> <when>;
<name> = bob | martha | joe | pete | chris | john | harold;
<when> = today | this afternoon | tomorrow | next week;
]]>
</grammar>

In this example, the elements named <command>, <name>, and <when> are rules of the grammar. Rules are a combination of a rulename and an expansion of a rule that advises an ASR engine or a voice interpreter which words presently can be recognized. In this example, expansion includes conjunction and disjunction, and the vertical bars ‘|’ mean ‘or.’ An ASR engine or a voice interpreter processes the rules in sequence, first <command>, then <name>, then <when>. The <command> rule accepts for recognition ‘call’ or ‘phone’ or ‘telephone’ plus, that is, in conjunction with, whatever is returned from the <name> rule and the <when> rule. The <name> rule accepts ‘bob’ or ‘martha’ or ‘joe’ or ‘pete’ or ‘chris’ or ‘john’ or ‘harold’, and the <when> rule accepts ‘today’ or ‘this afternoon’ or ‘tomorrow’ or ‘next week.’ The command grammar as a whole matches utterances like these, for example:
“phone bob next week,”
“telephone martha this afternoon,”
“remind me to call chris tomorrow,” and
“remind me to phone pete today.”

The voice server application (188) in this example is configured to receive, from a speech-enabled client device located remotely across a network from the voice server, digitized speech for recognition from a user and pass the speech along to the ASR engine (150) for recognition. ASR engine (150) is a module of computer program instructions, also stored in RAM in this example. In carrying out automated speech recognition, the ASR engine receives speech for recognition in the form of at least one digitized word and uses frequency components of the digitized word to derive a speech feature vector or SFV. An SFV may be defined, for example, by the first twelve or thirteen Fourier or frequency domain components of a sample of digitized speech. The ASR engine can use the SFV to infer phonemes for the word from the language-specific acoustic model (108). The ASR engine then uses the phonemes to find the word in the lexicon (106).

Also stored in RAM is a VoiceXML interpreter (192), a module of computer program instructions that processes VoiceXML grammars. VoiceXML input to VoiceXML interpreter (192) may originate, for example, from VoiceXML clients running remotely on speech-enabled devices, from X+V clients running remotely on speech-enabled devices, from SALT clients running on speech-enabled devices, from Java client applications running remotely on multimedia devices, and so on. In this example, VoiceXML interpreter (192) interprets and executes VoiceXML segments representing voice dialog instructions received from remote speech-enabled devices and provided to VoiceXML interpreter (192) through voice server application (188).

A speech-enabled application may provide voice dialog instructions, VoiceXML segments, VoiceXML <form> elements, and the like, to VoiceXML interpreter (149) through data communications across a network with such a speech-enabled application. The voice dialog instructions include one or more grammars, data input elements, event handlers, and so on, that advise the VoiceXML interpreter how to administer voice input from a user and voice prompts and responses to be presented to a user. The VoiceXML interpreter administers such dialogs by processing the dialog instructions sequentially in accordance with a VoiceXML Form Interpretation Algorithm (‘FIA’) (193). The VoiceXML interpreter interprets VoiceXML dialogs provided to the VoiceXML interpreter by a speech-enabled application.

As mentioned above, a Form Interpretation Algorithm (‘FIA’) drives the interaction between the user and a speech-enabled application. The FIA is generally responsible for selecting and playing one or more speech prompts, collecting a user input, either a response that fills in one or more input items, or a throwing of some event, and interpreting actions that pertained to the newly filled-in input items. The FIA also handles speech-enabled application initialization, grammar activation and deactivation, entering and leaving forms with matching utterances and many other tasks. The FIA also maintains an internal prompt counter that is increased with each attempt to provoke a response from a user. That is, with each failed attempt to prompt a matching speech response from a user an internal prompt counter is incremented.

Also stored in RAM (168) is an operating system (154). Operating systems useful in voice servers according to embodiments of the present invention include UNIX™, Linux™, Microsoft NT™, AIX™, IBM’s i5/OS™, and others as will occur to those of skill in the art. Operating system (154), voice server application (188), VoiceXML interpreter (192), ASR engine (150), JVM (102), and TTS Engine (194) in the example of FIG. 3 are shown in RAM (168), but many components of such software typically are stored in non-volatile memory also, for example, on a disk drive (170).

Voice server (151) of FIG. 4 includes bus adapter (158), a computer hardware component that contains drive electronics for high-speed buses, the front side bus (162), the video bus (164), and the memory bus (166), as well as drive electronics for the slower expansion bus (160). Examples of bus adapters useful in voice servers according to embodiments of the present invention include the Intel Northbridge, the Intel Memory Controller Hub, the Intel Southbridge, and the Intel I/O Controller Hub. Examples of expansion buses useful in voice servers according to embodiments of the present invention include Industry Standard Architecture (‘ISA’) buses and Peripheral Component Interconnect (‘PCI’) buses.

Voice server (151) of FIG. 4 includes disk drive adapter (172) coupled through expansion bus (160) and bus adapter (158) to processor (156) and other components of the voice server (151). Disk drive adapter (172) connects non-volatile data storage to the voice server (151) in the form of disk drive (170). Disk drive adapters useful in voice servers include Integrated Drive Electronics (‘IDE’) adapters, Small Computer System Interface (‘SCSI’) adapters, and others as will occur to those of skill in the art. In addition, non-volatile computer memory may be implemented for a voice server as an optical disk drive, electrically erasable programmable read-only memory (so-called ‘EEPROM’ or ‘Flash’ memory), RAM drives, and so on, as will occur to those of skill in the art.

The example voice server of FIG. 4 includes one or more input/output (‘I/O’) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. 3 includes a video adapter (209), which is an example of an I/O adapter specially designed for graphic output to a display device (180) such as a display screen or computer monitor. Video adapter (209) is connected to processor (156) through a high-speed video bus (164), bus adapter (158), and the front side bus (162), which is also a high-speed bus.

The example voice server (151) of FIG. 4 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for embodiments of the present invention include modems for wired dial-up communications, Ethernet (IEEE 802.3) adapters for wired data communications network communications, and 802.11 adapters for wireless data communications network communications.

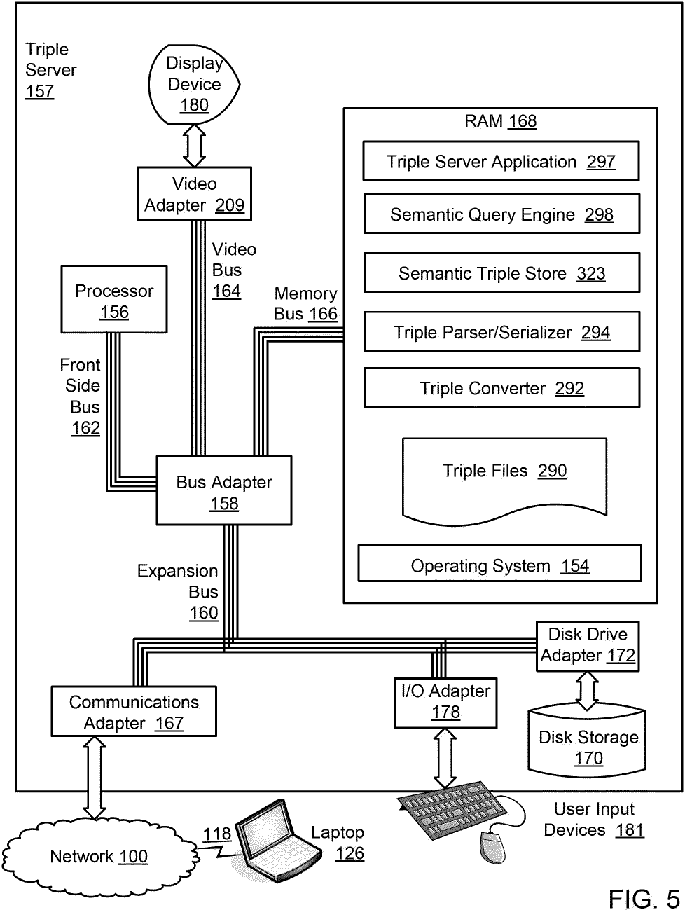

For further explanation, FIG. 5 sets forth a block diagram of automated computing machinery comprising an example of a computer useful as a triple server (157) for unified, cross-channel, multidimensional insight generation according to embodiments of the present invention. The triple server (157) of FIG. 5 includes at least one computer processor (156) or ‘CPU’ as well as random access memory (168) (‘RAM’) which is connected through a high-speed memory bus (166) and bus adapter (158) to processor (156) and to other components of the triple server. The processor is connected through a video bus (164) to a video adapter (209) and a computer display (180). The processor is connected through an expansion bus (160) to a communications adapter (167), an I/O adapter (178), and a disk drive adapter (172). The processor is connected to a speech-enabled laptop (126) through data communications network (100) and wireless connection (118). Disposed in RAM is an operating system (154).

Also disposed in RAM are a triple server application program (297), a semantic query engine (298), a semantic triple store (814), a triple parser/serializer (294), a triple converter (292), and one or more triple files (290). The triple server application program (297) accepts, through network (100) from speech-enabled devices such as laptop (126), semantic queries that it passes to the semantic query engine (298) for execution against the triple stores (323, 325).

The triple parser/serializer (294) administers the transfer of triples between triple stores and various forms of disk storage. The triple parser/serializer (294) accepts as inputs the contents of triple stores and serializes them for output as triple files (290), tables, relational database records, spreadsheets, or the like, for long-term storage in non-volatile memory, such as, for example, a hard disk (170). The triple parser/serializer (294) accepts triple files (290) as inputs and outputs parsed triples into triple stores. In many embodiments, when the triple parser/serializer (294) accepts triple files (290) as inputs and outputs parsed triples into triple stores.

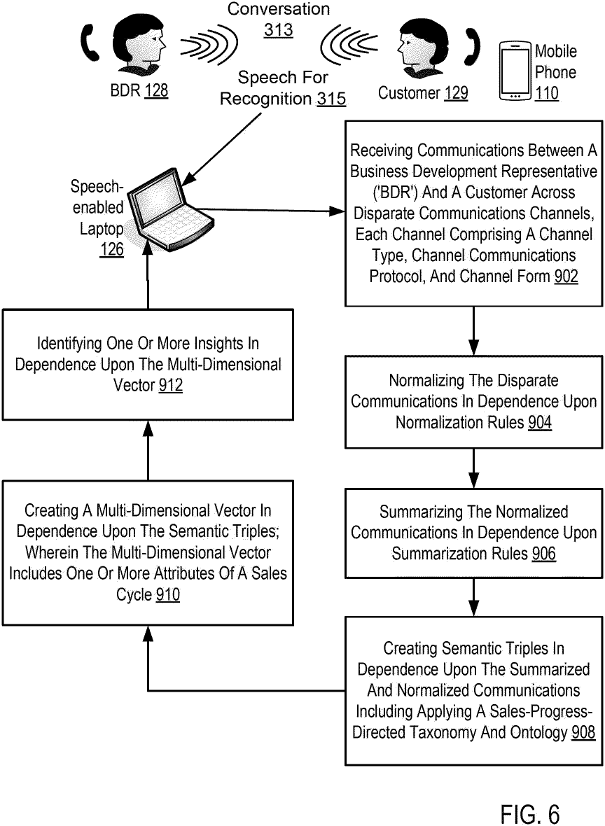

For further explanation, FIG. 6 sets forth a flowchart illustrating an example method of unified, cross-channel, multidimensional insight generation according to example embodiments of the present invention.

The method of FIG. 6 includes receiving (902) communications between a business development representative (‘BDR’) (128) and a customer (129) across disparate communications channels, each channel comprising a channel type, channel communications protocol, and channel form. Receiving (902) communications between a business development representative (‘BDR’) (128) and a customer (129) across disparate communications channels according to some embodiments of the present invention may be carried out by identifying through metadata associated with the communication, the channel type, communications protocol, and channel form. In some embodiments, the channel type, communications protocol, and channel form may be identified directly from metadata associated with the communications. However, in other embodiments, information regarding the communications may be inferred from the metadata.

The method of FIG. 6 includes normalizing (904) the disparate communications in dependence upon normalization rules. Normalizing (904) the disparate communications in dependence upon normalization rules may be carried out by applying rules to text representations of the communications to provide uniformity to text representations of communications of disparate types. Such rules may include converting the text to a uniform font such as all capitalized letters in the same font, applying uniform spacing between words in the text, and removing punctuation from the text.

The method of FIG. 6 includes summarizing (906) the normalized communications in dependence upon summarization rules. Summarizing the normalized communications may be carried out by reducing the overall content of the communications in a predetermined matter to focus the text of the communications for application of a taxonomy and ontology. In some embodiments, summarization rules may include removing predetermined adverbs, removing designated first words, adjusting or removing contractions, replacing known phrases with a standardized language pattern, and others as will occur to those of skill in the art.

The method of FIG. 6 includes creating (908) semantic triples in dependence upon the summarized and normalized communications including applying a sales-progress-directed taxonomy and ontology.

The method of FIG. 6 includes creating (910) a multidimensional vector in dependence upon the semantic triples; wherein the multidimensional vector includes one or more attributes of a sales cycle. Example attributes of a sales cycle include industry, BANT (budget, authority, need, and timeline), cost or pricing discussed on one or more sales calls, specific products discussed, key gatekeepers to the sales process, next best action in the customer relationship, a job title of the customer, cost of product questions and others. Identifying (912) one or more insights in dependence upon the multidimensional vector may include other types of insights including whether an interaction with a customer had positive sentiments, whether the sales cycle has positive momentum an others as will occur to those of skill in the art.

The method of FIG. 6 also includes identifying (912) one or more insights in dependence upon the multidimensional vector. Example insights include introductory talking points, best communications techniques such as email, chat, phone calls, objections to sales received, closing statements and sentiments, and others as will occur to those of skill in the art. Identifying the one or more insights in the example of FIG. 6 often includes identifying a stage in a sales cycle. Identifying one or more insights in dependence upon the multidimensional vector may include comparing the multidimensional vector with one or more predetermined vectors identifying stages in the sales cycle. Such comparison may include comparing vector distance in each dimension of the multidimensional vector individually, against a weighted prioritization, or other algorithms as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of unified, cross-channel, multidimensional insight generation, the method comprising:
receiving communications between a business development representative (‘BDR’) and a customer across disparate communications channels, each channel comprising a channel type, channel communications protocol, and channel form;
normalizing the disparate communications in dependence upon normalization rules;
summarizing the normalized communications in dependence upon summarization rules;
creating semantic triples in dependence upon the summarized and normalized communications including applying a sales-progress-directed taxonomy and ontology;
creating a multidimensional vector in dependence upon the semantic triples; wherein the multidimensional vector includes one or more attributes of a sales cycle; and
identifying one or more insights in dependence upon the multidimensional vector.

2. The method of claim 1 further comprising synchronizing the disparate communications for normalization.

3. The method of claim 1 wherein identifying the one or more insights includes identifying a stage in a sales cycle.

4. The method of claim 1 wherein normalizing the communications in dependence upon the type of communications channel includes:
identifying the native form of communications;
converting the native form of communications to text for parsing into semantic triples a product-specific sales taxonomy and ontology.

5. The method of claim 1 wherein normalizing the disparate communications comprises:
converting speech communications to text;
maintaining text communications in text; and
converting all text to a uniform font;
applying uniform spacing between words in the text; and
removing punctuation from the text.

6. The method of claim 4 wherein creating semantic triples in dependence upon the normalized communications includes parsing the summarized text into semantic triples according to the product-specific sales taxonomy and the ontology.

7. The method of claim 1 wherein identifying one or more insights in dependence upon the multidimensional vector comprises comparing the multidimensional vector with predefined vectors assigned to stages of a sales cycle.

8. The method of claim 1 wherein receiving communications between a business development representative and a customer across disparate communications channels comprises identifying from metadata associated with the communications the communications form.

9. The method of claim 1 wherein the dimensions of the multidimensional vector include next action for the BDR.

10. The method of claim 1 wherein the dimensions of the multidimensional vector include the industry of the customer or one or more products associated with the communications.

11. The method of claim 1 wherein the dimensions of the multidimensional vector include the budget, authority, need, and timeline.

12. A system of unified, cross-channel, multidimensional insight generation, the system comprising:
a channel engine configured for receiving communications between a business development representative (‘BDR’) and a customer across disparate communications channels, each channel comprising a channel type, channel communications protocol, and channel form;
a normalization and serialization engine configure for normalizing the disparate communications in dependence upon normalization rules and summarizing the normalized communications in dependence upon summarization rules;
a semantic database configured for creating semantic triples in dependence upon the summarized and normalized communications including applying a sales-progress-directed taxonomy and ontology;
an insight engine configured for creating a multidimensional vector in dependence upon the semantic triples; wherein the multidimensional vector includes one or more attributes of a sales cycle; and identifying one or more insights in dependence upon the multidimensional vector.

13. The system of claim 12 wherein identifying the one or more insights includes identifying a stage in a sales cycle.

14. The system of claim 12 wherein normalizing the communications in dependence upon the type of communications channel includes:
identifying the native form of communications;
converting the native form of communications to text for parsing into semantic triples a product-specific sales taxonomy and ontology.

15. The system of claim 12 wherein normalizing the disparate communications comprises:
converting speech communications to text;
maintaining text communications in text; and
converting all text to a uniform font;
applying uniform spacing between words in the text; and
removing punctuation from the text.

16. The system of claim 15 wherein creating semantic triples in dependence upon the normalized communications includes parsing the summarized text into semantic triples according to the product-specific sales taxonomy and the ontology.

17. The system of claim 16 wherein identifying one or more insights in dependence upon the multidimensional vector comprises comparing the multidimensional vector with predefined vectors assigned to stages of a sales cycle.

18. The system of claim 12 wherein receiving communications between a business development representative and a customer across disparate communications channels comprises identifying from metadata associated with the communications the communications form.

19. The system of claim 12 wherein the dimensions of the multidimensional vector include next action for the BDR.

20. The system of claim 12 wherein the dimensions of the multidimensional vector include the industry of the customer or one or more products associated with the communications.

21. The system of claim 12 wherein the dimensions of the multidimensional vector include the budget, authority, need, and timeline.
